(19) United States
(12) Patent Application Publication
(10) Pub. No.: US 2002/0117898 A1
(43) Pub. Date: Aug. 29, 2002

(54) Power-supply device for electrical components which are installed in a motor vehicle

(76) Inventor: Joel Leleve, Bobigny Cedex (FR)

Correspondence Address: MORGAN & FINNEGAN, L.L.P., 345 PARK AVENUE, NEW YORK, NY, 10154, US

(21) Appl. No.: 10/086,136

(22) Filed: Feb. 26, 2002

(30) Foreign Application Priority Data
Feb. 26, 2001 (FR) 0102682

(51) Int. Cl. B60L 1/14

(52) U.S. Cl. 307/10.8

(57) ABSTRACT

Power-supply device for 12-volt electrical components which are installed in a motor vehicle, in particular for components of the lighting or indicator system, from an electrical-energy source (E2) the voltage of which is higher than the rated voltage of 12 volts of the components, which are usually protected by a normal protection network when they are powered by a source at their rated voltage. The device includes elements (D1, C, Dz) which are identical or similar to those of a normal protection network placed at the head end of the 12 volt input of an electrical component (1), which are combined with a minimum number of additional active components (T) so as to produce a basic regulated power supply at 12 volts, which further ensures protection of the electrical component (1) which is equivalent to that of the normal protection network.

### FIELD OF THE INVENTION

The invention relates to a power-supply device for electrical components which are installed in a motor vehicle, in particular for components of the lighting or indicator system.

### BACKGROUND OF THE INVENTION

Electrical equipment is present in motor vehicles in ever-increasing amounts, so that an increase in the electrical power available becomes necessary, which, in practice, dictates an increase in the voltage of the electrical network of the vehicle, in order to avoid excessive current strengths.

In present-day private cars, the DC voltage of the mains is 12 volts. In the not too distant future this voltage will have to increase substantially, particularly to change to 42 volts.

This results in problems since, for the time being, many electrical components designed to operate at a voltage of 12 volts have no equivalents, in terms of cost and performance, which are suitable for a markedly higher DC voltage.

In the course of a transition period, components designed for a voltage of 12 volts will be retained, although the voltage of the network will be higher.

It is even possible that, after the transition period, some electrical equipment will continue to operate at a voltage of 12 volts for technological regions.

Thus, at the present time, an attitude-corrector device for a vehicle headlight uses a low-power electric motor, of the order of 5 watts; the wire of the winding has a reduced diameter, but the mechanical strength of this winding wire remains compatible, however, with high-throughput winding machines for economical mass-production with little wastage. If such a motor had to be designed to operate at a markedly higher voltage, for example 42 volts, the diameter of the winding wire would thereby be substantially reduced and, consequently, its mechanical tensile strength would be lowered, such that considerable problems with breaking of the wire on winding at high speed would be posed and would entail an unacceptable increase in cost.

Another example is that of the lamps used on motor vehicles for lighting, especially for the headlights. These lamps have to have filaments which are sufficiently mechanically strong because of the jolts produced when the vehicle is traveling. An increase in the operating voltage would entail a reduction in the cross-section of the filament which would be made mechanically fragile, with a reduced lifetime.

In order not to modify an electrical system operating at a DC voltage of 12 volts, although the electrical-energy source is at a higher voltage, the system can be preceded by a DC/DC converter. However, such a converter is costly, bulky and generates electromagnetic interference even if screening and filtering means are provided, which further increases the price of the converter.

A more economical approach consists in powering 12-volt lamps from a higher voltage by interposing a chopper. In the case of a voltage of 42 volts, if the duty cycle of the chopper is of the order of 1/9, the lamp “sees” an RMS voltage of the same order of magnitude as that of the 12-volt network. This chopper for a lamp may, moreover, be used to power other 12-volt systems, with a minimum of filtering by choke or resistor and capacitor. The use of a chopper is more economical than a converter, but it is difficult to manage on the basis of the currents consumed by the 12-volt system. In the case of a 12-volt actuator motor for headlamp-attitude correction, the consumption is essentially variable as a function of the variations in attitude of the vehicle. The conventional filtering means (choke, capacitor) do not make it possible to provide a DC voltage compatible with the operating range of the actuator (usually between 10 and 16 volts). The voltage at the terminals of the actuator, when the latter is in an idle period, may rise up to the value of 42 volts, which has to be avoided.

Moreover, a low-power, motor-vehicle electrical component or element operating at 12 volts is protected by a normal protection network consisting of a diode against voltage inversions, a filtering capacitor against the entry of currents induced on the power-supply lines and a Zener diode for protection against overvoltages.

### SUMMARY OF THE INVENTION

The object of the invention is, especially, to provide a simple power supply at 12 volts from a higher voltage, especially 42 volts, at the least cost, while providing protection for the electrical components which is equivalent to that of the usual 12-volt protection network.

The solution of the invention consists in taking elements which are identical or similar to those of a normal protection network placed at the head end of the 12-volt input of an electrical component, and in combining them with a minimum number of additional active components so as to produce a basic, regulated power supply at 12 volts, which, moreover, provides protection for the electrical components which is equivalent to that of the normal 12-volt protection network.

A power-supply device for 12-volt electrical components which are installed in a motor vehicle, in particular for components of the lighting or indicator system, from an electrical-energy source the voltage of which is higher than the rated voltage of 12 volts of the components, including a protection network for their power supply by a source at their rated voltage, is characterized by the fact that the protection network includes additional components in order to produce a basic regulated power supply at 12 volts from the electrical-energy source the voltage of which is higher than the rated voltage of 12 volts, and in that the voltage reference for the regulated power supply is a Zener diode (Dz), in particular with a Zener voltage equal to 12 volts, or close to this voltage.

A single additional active component is preferably provided, and consists of a transistor compatible with the currents and the voltages of the power-supply networks.

A Zener diode is used as voltage reference for the regulated power supply, with a Zener voltage equal to 12 volts, or close to this voltage, similar or identical to the Zener diode which serves for protection against overvoltages in a normal protection network.

Advantageously, the transistor for the regulated power supply is of the npn type with its base linked to the cathode of the Zener diode the anode of which is linked to earth, the collector of the transistor being linked to the cathode of a diode for protection against voltage inversions, the anode of this diode being linked to the positive terminal of the power supply; the base of the transistor is, furthermore, linked to its collector via a resistor, while the emitter of the transistor is linked to the load and while a capacitor for filtering against the entry of induced currents is wired in parallel between the emitter and earth.

The power supply for the regulated voltage source may advantageously be pulsed and originate from a filament-type lamp power supply. This makes it possible to use low-power components, essentially a transistor and resistor, for the regulation components, since they operate for only a fraction of the time, of the order of 1/9 in the case of a power supply on a 42-volt network.

The capacitor may be of low value, of the order of a few tens of μF (microfarads), depending on the frequency of the chopper and on the load.

The invention applies not only to the components of the lighting and indicating system, of low or medium power, especially less than 20 watts, but also to components of other systems of the vehicle, in particular LED lamps (light-emitting diode), neons, micromotors operating at 12 volts and which cannot be economically modified to be powered directly at 42 volts.

The economic advantage of the solution of the invention is obvious, since the additional cost of the device, by comparison with the usual protection network, is limited to a low-power transistor and a resistor.

Another advantage lies in the ease of integration. The two additional components are hardly bulky and give rise to no substantial modifications either to the printed circuit which carries them or to the space available in the environment of the printed circuit.

There is no significant additional cost for tooling and the constraints of validation are limited only to the additional components.

### BRIEF DESCRIPTION OF THE DRAWINGS

The invention consists, apart from the provisions set out above, in a certain number of other provisions which will be gone into more explicitly below in connection with an example described by reference to the attached drawing, but which is not in any way limiting. In this drawing:

FIG. 1 is an electrical diagram of a normal protection network for a low-power electrical component installed in a motor vehicle and powered at 12 volts;

FIG. 2 is a diagram of device according to the invention for supplying power at 12 volts from a higher voltage;

FIG. 3 shows, diagrammatically in perspective, a normal printed circuit of an attitude corrector for a motor-vehicle headlight, designed to operate at 12 volts; and

FIG. 4 shows, in a similar way to FIG. 3, the printed circuit modified according to the invention in order to power the corrector at 12 volts, from a higher voltage.

### DESCRIPTION OF PREFERRED EMBODIMENTS OF THE INVENTION

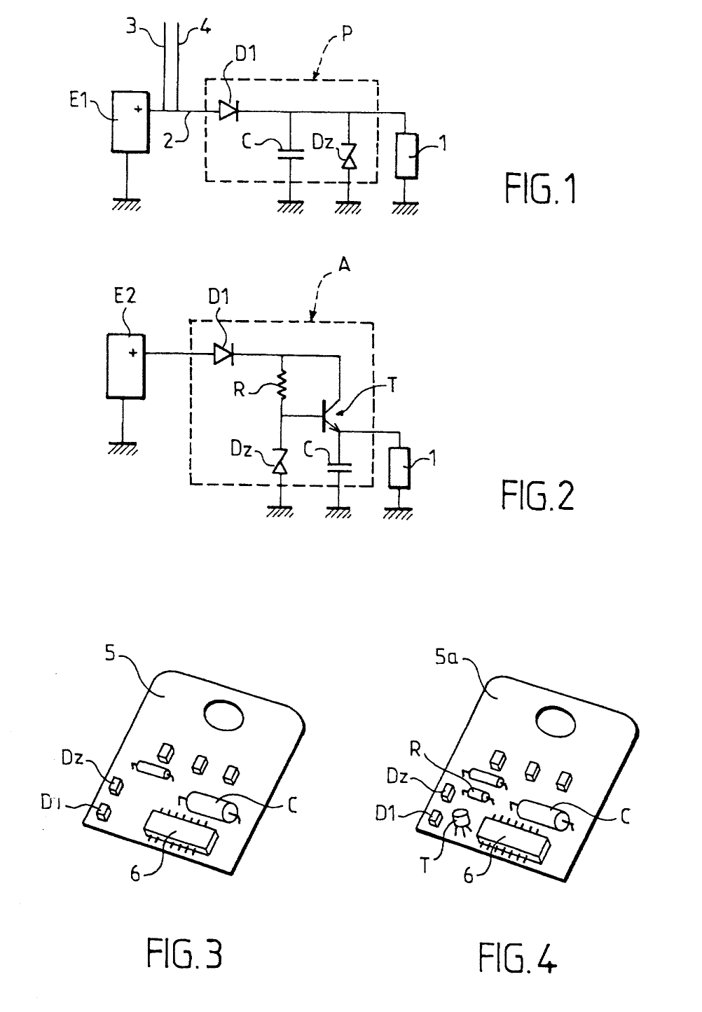

Referring to FIG. 1, a conventional power-supply diagram can be seen, with a normal protection network P, for an electrical component 1 installed in a motor vehicle. The component 1 is designed to operate at a DC voltage of 12 volts, and is powered from an energy source E1 the voltage of which is also 12 volts.

The component 1 may be a component of the lighting or indicator system of the vehicle, especially an actuator motor for correcting the attitude of a headlight of the vehicle. Such a motor has a low power, of the order of 5 watts.

One terminal of the component 1 is linked to earth and another terminal is linked via a conductor 2 to the + terminal of the source E1. Other conductors 3, 4 are linked to the + terminal of the source E1 so as to power various pieces of apparatus, which are capable of creating overvoltages on the line 2.

The usual protection network P, provided at the head end of the input of the component 1, comprises a diode D1 for protection against polarity inversions, the anode of which is linked to the + terminal of the source E1 and the cathode of which is linked to the input terminal of the component 1. The network P further comprises a filtering capacitor C wired in parallel between the cathode of the diode D1 and earth, as well as a Zener diode Dz against overvoltages. The Zener diode is wired between earth and the input terminal of the component 1; the Zener voltage of this diode is slightly higher than the maximum operating voltage of the component 1, namely 18 volts.

FIG. 2 is the diagram of the device A according to the invention, which makes it possible to power the component 1 at its rated voltage of 12 volts from an energy source E2 the voltage of which is higher, especially equal to 42 volts, while providing protection for the component 1 which is equivalent to that obtained with the network P of FIG. 1.

The power-supply device A of FIG. 2 includes elements which are identical or similar to those of the network P. They will be designated by the same references. These elements are combined differently with an active component formed by a transistor T so as to form a basic regulated power supply.

The transistor T, of npn type, is chosen to be compatible with the currents and the voltages brought into play for the power supply to the component 1. The base of this transistor T is linked to the cathode of the Zener diode Dz the anode of which is linked to earth. A resistor R links the cathode of the diode D1 to the cathode of the diode Dz. The anode of D1 is linked to the + terminal of the source E2. The collector of the transistor T is linked to the cathode of the diode D1. The emitter of the transistor T is linked to the input terminal of the component 1. The capacitor C is wired between the emitter of the transistor T and earth.

It is apparent that the power supply A includes, as additional elements by comparison with the network P of FIG. 1, only a single active component formed by the transistor T and a passive component consisting of the resistor R.

The operation of the power supply A is as follows.

The transistor T reproduces, at the terminals of the load 1, the Zener voltage of the diode Dz, that is to say substantially 12 volts. If the voltage at the terminals of the load 1 has a tendency to exceed the Zener voltage applied to the base of the transistor T, the latter is reverse-biased and turns off. Protection of the load 1 against overvoltages is thus ensured.

The power supply for the circuit A can be pulsed and originate from a chopper constituting the source E2 and powering the circuit by way of 42-volt pulses according to a defined duty cycle of about 1/9. That makes it possible, in the circuit A, to use low-power elements since they are operating only a fraction (1/9) of the time. The capacitor C has a low value, of the order of a few tens of μF (microfarads), depending on the frequency of the chopper and on the load.

FIG. 3 diagrammatically shows a normal printed circuit for powering a 12-volt attitude-corrector motor, from a 12-volt source. On the board 5 of the circuit are installed various elements such as an integrated circuit 6, a capacitor C, a diode D1 for protection against polarity inversions, and a Zener diode Dz. The connections provided under the board 5 are not visible.

FIG. 4 shows the printed circuit according to the invention making it possible to power the same motor at 12 volts from a 42-volt source. The same elements are found again on the board 5a of the circuit, supplemented by the transistor T and the resistor R the installation of which on the card 5a does not create any difficulty. The connections under the card 5a are formed according to the diagram of FIG. 2.

The additional cost of the power-supply device A, by comparison with the usual protection network P, is limited to a low-power transistor T and a resistor R.

The transistor T and the resistor R are hardly bulky and do not give rise to any significant modification either to the printed circuit which carries them or to the space available in the environment of the printed circuit. There is no significant additional cost for tooling, and the constraints of validation are limited only to the additional component T and R.

What is claimed is:

1. Power-supply device for 12-volt electrical components which are installed in a motor vehicle, in particular for components of the lighting or indicator system, from an electrical-energy source the voltage of which is higher than the rated voltage of 12 volts of the components, including a protection network for their power supply by a source at their rated voltage, wherein the protection network includes additional components in order to produce a basic regulated power supply at 12 volts from the electrical-energy source the voltage of which is higher than the rated voltage of 12 volts, and in that the voltage reference for the regulated power supply is a Zener diode, in particular with a Zener voltage equal to 12 volts, or close to this voltage.

2. Power-supply device according to claim 1, which includes a single additional active component consisting of a transistor compatible with the currents and the voltages of the power-supply network.

3. Power-supply device according to claim 2, wherein the transistor is of the npn type.

4. Power-supply device according to claim 3, wherein the base of the transistor is linked to the cathode of the Zener diode the anode of which is linked to earth, the collector of the transistor being linked to the cathode of a diode for protection against voltage inversions, the anode of this diode being linked to the positive terminal of the power supply, and the base of the transistor is, furthermore, linked to its collector via a resistor, while the emitter of the transistor is linked to the load and while a capacitor for filtering against the entry of induced currents is wired in parallel between the emitter and earth.

5. Power-supply device according to claim 1, wherein the electrical-energy source is pulsed.

6. Power-supply device according to claim 5, wherein the electrical-energy source comprises a chopper.

7. Power-supply device according to claim 1, wherein the voltage of the electrical-energy source is 42 volts.

8. Power-supply device according to claim 5, wherein the duty cycle of the pulsed source is of the order of 1/9.

9. Vehicle-headlight attitude corrector, which includes a power-supply device according to claim 1.
